(19) United States
(12) Patent Application Publication
(10) Pub. No.: US 2009/0081417 A1
(43) Pub. Date: Mar. 26, 2009

(54) HIGH TEMPERATURE THERMOFORMED WEBS FOR PACKAGING AND COOKING OF FOOD PRODUCTS

(75) Inventors: Michael D. SCHMAL, Orwigsburg, PA (US); Ernest E. BACHERT, Orwigsburg, PA (US)

Correspondence Address: Pepper Hamilton LLP, 400 Berwyn Park, 899 Cassatt Road, Berwyn, PA, 19312-1183, US

(73) Assignee: M&Q PACKAGING CORPORATION, Schuylkill Haven, PA (US)

(21) Appl. No.: 12/233,204

(22) Filed: Sep. 18, 2008

Related U.S. Application Data
(60) Provisional application No. 60/973,963, filed on Sep. 20, 2007.

(51) Int. Cl. B32B 3/06; B29C 65/00

(52) U.S. Cl. 428/192; 156/60

(57) ABSTRACT

High temperature thermoformed webs for use in high temperature processes. Suitable high temperature processes include cooking food products, such as whole muscle meats, and sterilization of medical instruments. The high temperature thermoformed webs are comprised of films comprising materials that can withstand high temperatures and also have other beneficial properties such as the ability to be thermoformed, can be readily heat sealed, durability, good tear strength, puncture resistance, good moisture barrier properties, and good gas barrier properties. These thermoformed webs can withstand temperatures greater than the boiling point of water, i.e., 212° F., preferably greater than 300° F. and more preferably greater than 350° F. Also, methods of making thermoformed webs for packaging and high temperature cooking/sterilization of products.

### CROSS REFERENCE TO RELATED APPLICATIONS

This application claims the benefit of U.S. Application 60/973,963 filed Sep. 20, 2007, the disclosure of which is being incorporated herein by reference in its entirety.

### TECHNOLOGY FIELD

The present invention relates generally to thermoformed webs used for high temperature processes, and more particularly to thermoformed webs that can be used to package products for storage and high temperature applications.

### BACKGROUND

A popular method for packaging products is through the use of thermoformed webs. Suitable products may include food products, meat products, and medical devices. The process of producing thermoformed webs involves two distinct components. The first component is the webbing stock that is thermoformed. The second component, referred to as lidding stock, is sealed to the web to form a hermetically sealed package.

Traditional thermoformed webs are either comprised of a monolithic structure, such as 100% polyester, or a co-extruded structure, such as polyethylene with nylon, polyethylene with polyester, or polyethylene with polypropylene. A requirement of the web material is that it contains at least one layer with a base material that can be thermoformed. To thermoform a material, the material must be heated to a temperature above its glass transition temperature but below its crystalline melt point so that the material is softened, but does not melt. The material may then be drawn into the shape of, for example, a tub or container using, for example, vacuum assist, mechanical pressure, or air pressure to form the web into a female die. Alternatively, a male portion of the die may be used to push the material into the female portion of the die. After the web is thermoformed, product may be placed into the thermoformed tray, and subsequently, lidding stock may be applied to hermetically seal the package.

Traditional lidding stock is comprised of a material such as polyester, nylon, ethylene-vinyl alcohol (EVOH), or some other material that has been co-extruded or laminated with a heat seal layer, such as polyethylene or polypropylene.

Typically, these packages are very durable. These conventional thermoformed packages, however, can not be exposed to high temperatures, i.e., food cannot be cooked in these packages. There are several reasons for this. First, the materials used to heat seal the webs have low melt points to facilitate the heat sealing process. Accordingly, cooking at a temperature above the melt point leads to degradation of the web and destruction of the food product being cooked. Furthermore, Food and Drug Administration regulations require that cooking of food products in these materials be performed in temperatures below the boiling point of water. Accordingly, the cooking range for these bags is typically between 180° F. and 210° F.

Traditional thermoformed webs have other drawbacks. These include poor moisture or gas barrier properties and affinity of food products to the web's surface during or after the cooking process leading to food sticking to the container.

Accordingly, a thermoformed web that can be used for cooking at high temperatures is desirable. Also thermoformed webs that can be readily heat sealed, have good gas barrier properties, and/or good moisture barrier properties would be desirable.

### SUMMARY

Certain embodiments of the present invention are directed to a high temperature thermoformed web comprising: a web stock; one or more open webs thermoformed in the web stock; a ridge extending around the perimeter of each of the one or more webs; and a lidding stock that is attached to the ridge of the web stock to cover the one or more webs forming a closed web, wherein the high temperature thermoformed web is suitable for use in a high temperature process that occurs at greater than about 212° F.

In one embodiment, the web stock comprises a core layer comprising nylon blended with a polyester elastomer or a polyamide elastomer. In another embodiment, the web stock comprises a multi-layer film; the multi-layer film comprising: a heat seal layer on an interior of the web stock; a core layer on an exterior of the web stock; and a tie layer between the heat seal layer and core layer.

In one embodiment, the present invention is directed to a thermoformed web wherein the heat seal layer comprises a polyester elastomer or a polyamide elastomer, the core layer comprises nylon, and the tie layer comprises nylon blended with a polyester elastomer or a polyamide elastomer. In another embodiment, the thermoformed web further comprises an outer core layer, outside of the core layer. In one embodiment, the core layer comprises nylon 6 and the outer core layer comprises nylon 6,6.

In certain embodiments, the present invention is directed to a thermoformed web, wherein the lidding stock comprises a core layer comprising nylon blended with polyester elastomer or polyamide elastomer. In one embodiment, the lidding stock comprises a multi-layered film comprising: a core layer on an exterior of the lidding stock and a heat seal layer on an interior of the lidding stock. In one embodiment, the core layer comprises nylon or polyester and the heat seal layer comprises nylon blended with polyester elastomer or polyamide elastomer. In another embodiment, the thermoformed web comprises a lidding stock further comprising a tie layer between the core layer and the heat seal layer. In another embodiment, the thermoformed web comprises a lidding stock wherein the core layer is nylon or polyester, the heat seal layer is a polyester elastomer or polyamide elastomer, and the tie layer is nylon or polyester, blended with a polyester elastomer or a polyamide elastomer.

In certain embodiments, The thermoformed web is used for a high temperature process wherein the high temperature process is cooking of a food product. In other embodiments, the high temperature process is sterilization of medical instruments. In preferred embodiments, the high temperature process occurs at greater than about 300° F. In more preferred embodiments, the high temperature process occurs at greater than about 350° F. In certain embodiments, the high temperature process comprises a high temperature food preparation process that occurs from about 212° F. to about 400° F.

In certain embodiments, the thermoformed web comprises a lidding stock capable of venting, wherein the lidding stock loosens from the web stock to allow venting of gasses from the thermoformed web.

In certain embodiments, the thermoformed web has a tensile yield strength of greater than about 2000 psi. In certain embodiments, the thermoformed web has an oxygen barrier transmission coefficient of approximately 30 cc/24 hr/100 in²/mil. In certain embodiments, the thermoformed web has a water vapor barrier transmission coefficient of approximately 40 g/24 hr/100 in²/mil. In certain embodiments, the thermoformed web does not substantially adhere to food during or after said high temperature food preparation process. Certain embodiments of the present invention are directed to a thermoformed web wherein the inner layer of web stock and inner layer of lidding stock are heat sealable to one another. In certain embodiments, the tie layer comprises at least 75% (by weight) nylon.

Certain embodiments of the present invention is directed to a method of making thermoformed webs for packaging and high temperature cooking of food products comprising: heating a web stock film; thermoforming one or more webs in said web stock film to form a web tray; placing a product into at least one web; sealing the web tray with a lidding stock to form a sealed web tray; and cutting the web tray to produce individual thermoformed webs; wherein the thermoformed webs are capable of cooking a product at a temperature above 212° F.

In another embodiment, a method further provides: a core layer comprising a core material; a heat seal layer comprising a polyester elastomer or a polyamide elastomer; and blending the elastomeric material of the heat seal layer with the core material of the core layer to form a tie layer wherein at least 75% (by weight) of the tie layer comprises core material; and tying the core layer and heat seal layer using the tie layer.

Another embodiment is directed to a method wherein the thermoformed web is used for a food packaging, storage, and cooking system.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention will become apparent from the following detailed description of the invention when considered in conjunction with the accompanying drawings. For the purpose of illustrating the invention, there is shown in the drawings embodiments that are presently preferred, it being understood, however, that the invention is not limited to the specific instrumentalities disclosed. In the drawings:

FIG. 1 is a cross sectional view of an exemplary monolayer film used in the formation of a high temperature web stock;

FIG. 2 is a cross sectional view of an exemplary multilayer film, comprising three layers, used in the formation of a high temperature web stock;

FIG. 3 is a cross sectional view of an exemplary multilayer film, comprising four layers, used in the formation of a high temperature web stock;

FIG. 4 is a cross sectional view of an exemplary film, comprising one layer, used in the formation of a high temperature lidding stock;

FIG. 5 is a cross sectional view of an exemplary multilayer film, comprising two layers, used in the formation of a high temperature lidding stock;

FIG. 6 is a cross sectional view of an exemplary multilayer film, comprising three layers, used in the formation of a high temperature lidding stock;

FIG. 7 is a top view schematic of an exemplary method for making an exemplary thermoformed web from a web stock and a lidding stock; and

FIG. 8 is a side view schematic of an exemplary method for making an exemplary thermoformed web from a web stock and a lidding stock.

### DETAILED DESCRIPTION OF ILLUSTRATIVE EMBODIMENTS

The present invention is directed to embodiments of high temperature thermoformed webs. As used herein, high temperature may be defined as able to withstand temperatures greater than the boiling point of water, i.e., 212° F. In accordance with preferred embodiments, high temperature thermoformed webs can withstand temperatures greater than the boiling point of water, i.e., 212° F.; preferably greater than about 300° F.; and more preferably greater than about 350° F.

The thermoformed webs comprise a web stock and a lidding stock. The web stock and lidding stock are comprised of films comprising materials that can withstand high temperatures. The web stock is a material that may be thermoformed. The materials may include other beneficial properties such as, for example: the ability to be readily heat sealed; durability; good tear strength; good puncture resistance; good moisture barrier properties; and good gas barrier properties. When applied to packaging of food products, the present invention allows for food products to be cooked in the same package that they were packaged and stored in.

Suitable films include those that can withstand high temperatures, yet are capable of heat sealing on conventional or modified thermoforming lines. Suitable films may comprise a single layer or multiple layers. Furthermore, suitable film structures for the web stock include at least one layer that is thermoformable. A layer is thermoformable if it is able to be shaped by heat and pressure.

The web stock and the lidding stock may have an interior and an exterior. For the web stock, the interior is the portion of the web that is in contact with the product. The exterior is the outside of the web. For the lidding stock, the interior is the portion that is in contact with the web stock via the heat seal layer and the product. The exterior is the outside of the lidding stock.

The web stock may be relatively thick, because it may be drawn down into wells to form the web structures. Preferably, the web stock thickness is between about 2 mils and about 6 mils. More preferably, the web stock thickness is between about 2.5 mils and about 4 mils. After the web stock is drawn down into webs, the thickness may be around 2 mils. The lidding stock may be relatively thin as compared to the web stock, because it does not need to be drawn down. Preferably, the lidding stock thickness is between about 0.8 mils and about 3 mils. More preferably, the lidding stock thickness is between about 1 mil and about 2 mils.

Several materials may be used to construct films for high temperature web stock or lidding stock. The web and lidding stock materials include the ability to high temperature cook directly in the thermal formed web. Suitable materials may meet at least one, if not more, of the following characteristics: capability to be thermoformed (for the web stock); high melting point; can be readily heat sealed; good strength/puncture resistance; substantially does not adhere to food products; and good barrier properties such as gas and/or moisture barrier properties. Suitable materials include polyester elastomer, polyamide elastomer, nylon, polyester, and polypropylene.

One characteristic for a suitable material is good barrier properties such as gas and moisture. As used herein, a material with a suitable gas barrier property has an oxygen barrier transmission coefficient of approximately 30 cc/24 hr/100 in²/mil or less. Preferably, the oxygen barrier transmission coefficient is approximately 10 cc/24 hr/100 in²/mil or less. As used herein, a material with a suitable moisture barrier property has a water vapor barrier transmission coefficient of approximately 40 g/24 hr/100 in²/mil or less. Preferably, the water vapor barrier transmission coefficient is approximately 10 g/24 hr/100 in²/mil or less.

Another characteristic for a suitable material is a good tear strength. As used herein, a material with a good tear strength has a tear strength greater than about 50 g/mil. In a more preferred embodiment, a material with a good tear strength has a tear strength of greater than about 75 g/mil. A suitable material may also have a good tensile yield strength. As used herein, a material with a good tensile yield strength has a tensile yield strength of greater than approximately 2,000 psi. Preferably, the tensile yield strength is greater than approximately 2,500 psi. In certain embodiments, the tear strength, puncture resistance, and tensile yield strengths of the film are improved through the combination of multiple layers in a multi-layer film.

Another characteristic for a suitable material is one that substantially does not adhere to food products during or after the cooking of food products. As used herein, substantially does not adhere to food products may be defined as less than 5% weight of the food product sticking to the package.

The characteristics and properties of the films may be dependent on one or more factors including: the material, the thickness of the material, the type of process used to produce the material (i.e., blown film, cast film, etc.). Embodiments of the invention contemplate selection of materials, and design and construction of the film to achieve desired characteristics and properties. For example, the thickness and process used to make a material may be allow properties to overlap between materials.

Polyester elastomer is a high temperature polymer with a crystal melting point typically around 423° F. The material is also elastic and the elasticity of the polymer when blended or co-extruded with other materials improves package integrity. The elasticity adds impact strength, tear resistance, improves seal strength, improves tensile properties, increases the properties of the force needed to break the web and improves bone puncture resistance. Furthermore, polyester elastomer does not stick to proteins found in whole muscle meat products. Polyester elastomer can be used as a layer by itself, or can be blended with other materials to form a layer. Suitable materials that can be blended with polyester elastomer include: polyester, polyamide elastomer, and nylon. Suitable polyester elastomers include ARNITEL®, ARNITEL® EM630, HYTREL®, and RITEFLEX®.

Polyamide elastomer is similar to polyester elastomer. Polyamide elastomer generally has a melt point around approximately 380° F. to 400° F. Polyamide elastomer can be used as a layer by itself, or can be blended with other materials to form a layer. Suitable materials that can be blended with polyamide elastomer include polyester, polyester elastomer, and nylon. Suitable polyamide elastomers include PEBAX® and PEBAX® 4033.

Homopolymer nylon is another suitable material for a layer within a high temperature film. Nylon has exceptional oxygen, carbon dioxide and nitrogen barrier properties, among others. Accordingly, it can be used as a barrier layer in a film structure that will maintain a vacuum or could be used in a gas flush package. Nylon can be used as a layer by itself, or can be blended with other materials to form a layer. Suitable materials that can be blended with nylon include: polyester, polyamide elastomer, and polyester elastomer. Suitable nylon includes AKULON®, AKULON® F136 C1 which is a nylon 6, ULTRAMID®, ULTRAMID B40 LN01 which is a nylon 6, ASCEND®, SOLUTIA 66J, which is a nylon 6,6 containing a heat stabilizer, and UTRAMID C33 which is a nylon 6,6/6 co-polymer.

In certain embodiments, heat stabilizers may be added to nylon to improve its heat stability. Although nylon has a relatively high melt point, approximately 423° F., without the addition of a heat stabilizer, nylon will become brown and brittle at temperatures higher than approximately 325° F. Suitable heat stabilizers include copper salts such as copper iodide, copper bromide, and copper acetate.

Another suitable material for high temperature films is polyester. Polyester has very good moisture barrier qualities. Suitable polyesters include VERSATRAY™ and VERSATRAY™ 12822.

Even more suitable is oriented polyester. Oriented polyester has improved barrier properties and also has shrink properties not found in non-oriented polyester. Furthermore, oriented polyester has a higher continuous use temperature than non-oriented polyester. Accordingly, oriented polyester may be used in high temperature processes up to 400° F. without any significant signs of crystallization or melting. Polyester may be more easily oriented if blended with a small amount of polyester elastomer. Suitable amounts of polyester elastomer range from about 5% to about 25% (by weight).

For example, when producing multi-layer films, the individual layers are preferably combined using a method that does not decrease the thermoformed web's ability to be used for high temperature cooking. A suitable method to accomplish this is through the use of tie layers. A tie layer is an intermediate layer between two layers of dissimilar materials. The tie layer may be comprised of materials of the layers in which it is between. This composition facilitates good adhesion of the layers because each layer is attached to a layer comprised, at least in part, of like materials. For example, to join a polyester layer with a nylon layer, a tie layer comprising a polyester elastomer blended with nylon would be suitable.

In certain embodiments, layers comprise a blend of a base material, such as polyester or nylon, with an elastomer material such as polyester elastomer or polyamide elastomer. Preferably, the percentage of base material in the layer is at least about 75% (by weight). In certain embodiments, the percentage of base material in the layer is at least about 80% (by weight). In other embodiments, the percentage of base material in the layer is at least about 90% (by weight).

In certain embodiments, the thermoform web and lidding stock is designed to “vent” during cooking. Venting occurs when the lidding stock is comprised of a film that has a softening point lower than the usable temperature of the rest of the vessel, i.e., the web. Softening point may be defined as the temperature at which a material will no longer hold a heat seal. The usable temperature may be defined as the temperature at which the vessel may still be used for high temperature processes. Preferably, the softening point of the lidding stock film is greater than about 212° F.

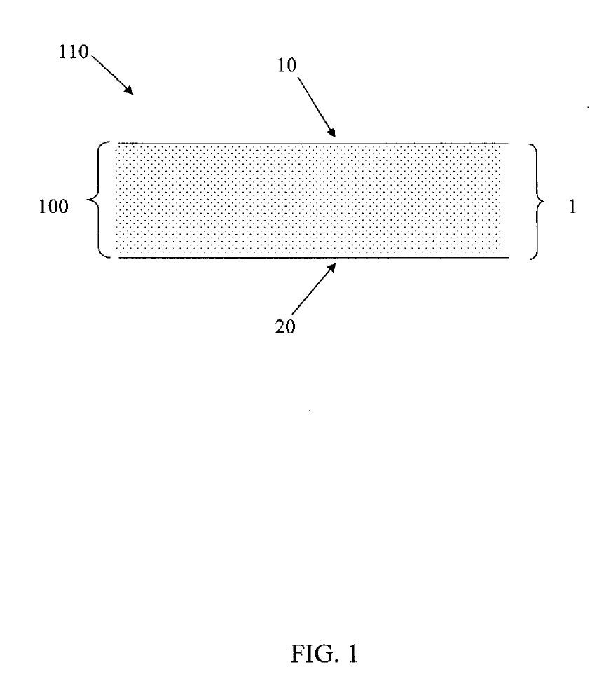

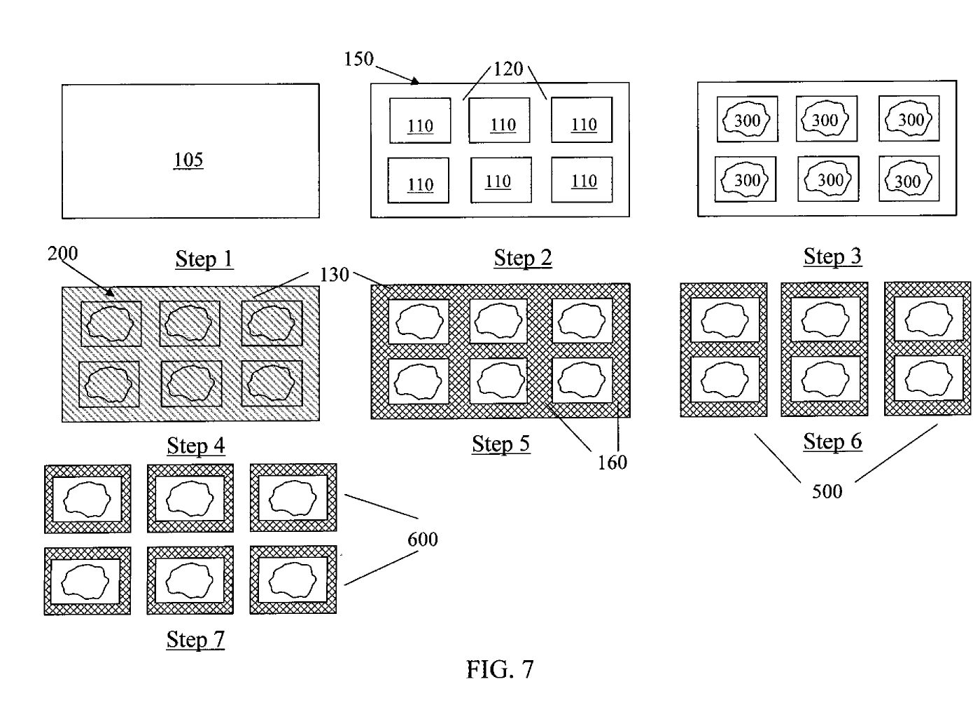

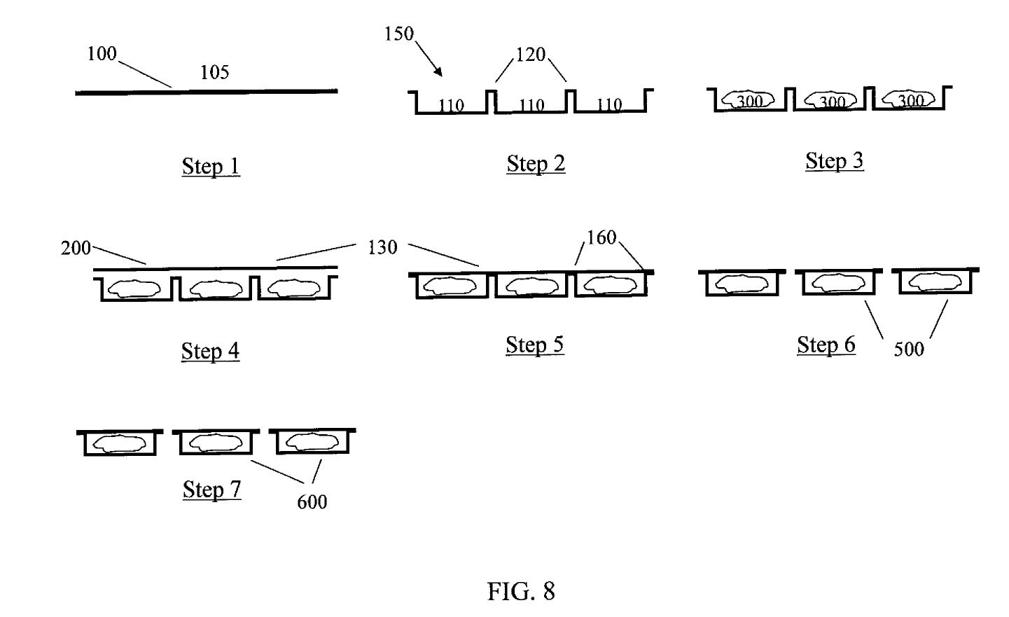

FIGS. 1-6 illustrate exemplary embodiments of the web stock 110 and lid stock 130. FIGS. 7 and 8 illustrate how the web stock 110 and lid stock 130 may be combined to package a food product. It should be understood that the various embodiments of the web stock 110 may be combined with any of the various embodiments of the lid stock 130. For example, the web stock 110 may be multilayer and the lid stock 130 may be single layer; the web stock 110 may be single layer and the lid stock 130 may be multilayer; the web stock 110 may be single layer and the lid stock 130 may be single layer; and the web stock 110 may be multilayer and the lid stock 130 may be multilayer.

FIG. 1 is a cross sectional view of an exemplary monolayer film 100, used in the formation of web stock 110 wherein the film comprises a core layer 1. The monolayer film 100 comprises as interior 10 and an exterior 20. In one embodiment, the core layer 1 for this structure comprises nylon blended with polyester elastomer. In another embodiment, the core layer 1 comprises nylon blended with polyamide elastomer.

The film of this embodiment has several benefits. First, this film is suitable for high temperature applications. Furthermore, this embodiment is easier to thermoform than a film comprising 100% nylon. Also, the blend of dissimilar melt point polymers provides for a wider heat seal window, thus making it easier to heat seal than a single material such as 100% nylon. In addition, the polyester elastomer will reduce meat adhesion to the web during cooking.

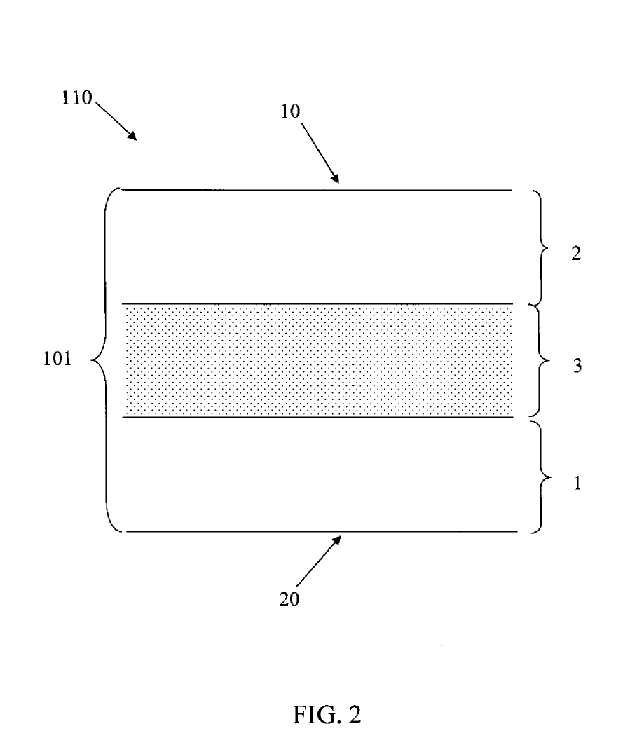

FIG. 2 is a cross sectional view of an exemplary multilayer film 101, comprising three layers, used in the formation of a high temperature web stock 110. The multilayer film 101 comprises an interior 10 and an exterior 20. In this embodiment, the film 101 comprises a core layer 1, a heat seal layer 2, and a tie layer 3. In a preferred embodiment, the core layer 1 comprises nylon, the heat seal layer 2 comprises a polyester elastomer or a polyamide elastomer, and the tie layer 3 comprises nylon blended with a polyester elastomer or a polyamide elastomer.

In one embodiment, the amount of nylon in the tie layer is greater than about 75% (by weight). In another embodiment, the amount of nylon in the tie layer is greater than about 80% (by weight). In yet another embodiment, the amount of nylon in the tie layer is greater than about 90% (by weight).

This embodiment provides several benefits. First, this film is suitable for high temperature applications. Second, because the core layer comprises 100% nylon, this web will have superior gas barrier properties. Third, a heat seal layer comprising 100% elastomer provides for a web that is easily heat sealed. Furthermore, the polyester elastomer or polyamide elastomer on the interior of the web also minimizes meat adhesion. Moreover, the tie layer of nylon blended with a polyester elastomer or polyamide elastomer allows for superior adhesion between the core layer and heat seal layer.

In another embodiment, the web stock may also comprise a two layer structure. The two layer film may be comprised of a heat seal layer of 100% polyester elastomer and a core layer which is a blend of nylon and polyester.

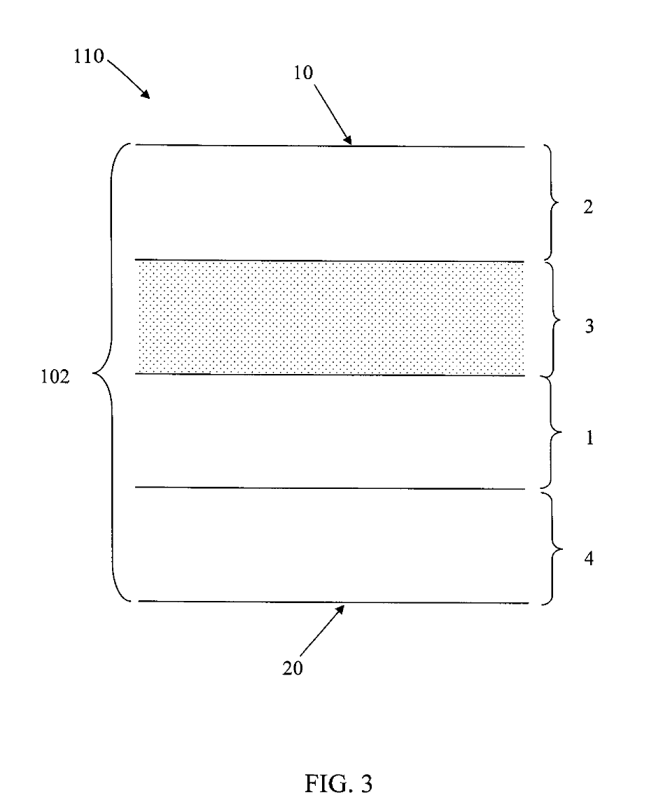

FIG. 3 is a cross sectional view of an exemplary multilayer film 102, comprising four layers, used in the formation of a high temperature web stock 110. The multilayer film 102 comprises an interior 10 and an exterior 20. In this embodiment, the film comprises a core layer 1, a heat seal layer 2, a tie layer 3, and an outer core layer 4.

In a preferred embodiment, the core layer 1 comprises nylon 6, the heat seal layer 2 comprises polyester elastomer or polyamide elastomer, the tie layer 3 comprises nylon blended with polyester elastomer or polyamide elastomer, and the outer core layer 4 comprises nylon 6,6.

In one embodiment, the amount of nylon in the tie layer is greater than about 75% (by weight). In a more preferred embodiment, the amount of nylon in the tie layer is greater than about 80% (by weight). In a most preferred embodiment, the amount of nylon in the tie layer is greater than about 90% (by weight).

This embodiment provides several benefits. First, this film is suitable for high temperature applications. Second, because the core layer comprises 100% nylon, this web will have superior gas barrier properties. Third, a heat seal layer comprising 100% elastomer provides for a web that is easily heat sealed. Furthermore, the polyester elastomer or polyamide elastomer on the interior of the web minimizes meat adhesion during cooking. The tie layer of nylon blended with a polyester elastomer or polyamide elastomer allows for superior adhesion between the core layer and heat seal layer. The outer core layer comprised of nylon 6,6 has a higher melting point than nylon 6, thus making the structure more stable in higher temperatures. Nylon 6, however, is easier to thermoform than nylon 6,6. A film with layers of both nylon 6 and nylon 6,6 provides for a structure that is both easily thermoformed and stable at temperatures higher than the melting point of nylon 6.

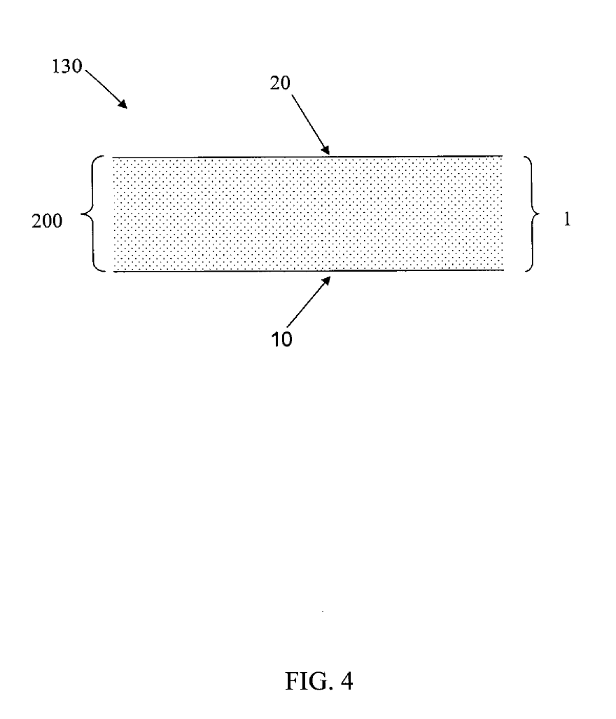

FIG. 4 is a cross sectional view of an exemplary monolayer film 200 used in the formation of a high temperature lidding stock 130. The monolayer film 200 comprises an interior 10 and an exterior 20. As shown, film 200 comprises a core layer 1. In one embodiment, the core layer 1 comprises nylon blended with polyester elastomer. In another embodiment, the core layer 1 comprises nylon blended with polyamide elastomer.

In one embodiment, the amount of nylon in the core layer 1 is greater than about 75% (by weight). In a more preferred embodiment, the amount of nylon in the core layer 1 is greater than about 80% (by weight). In a most preferred embodiment, the amount of nylon in the core layer 1 is greater than about 90% (by weight).

The film in this embodiment is suitable for high temperature applications. Also, the film of this embodiment is superior to a film comprising 100% nylon because the blend of dissimilar melt point polymers provides for a wider heat seal window. This makes the film easier to heat seal than a single material such as 100% nylon. Furthermore, the polyester elastomer will reduce meat adhesion to the lid during or after the cooking process.

In another embodiment, the core layer 1 may be comprised of a material that is capable of venting. One benefit of these materials is that at a certain temperature, these materials loosen from the thermorformed web, thus breaking the seal and allow the contents within the web to vent. Preferably, the film loosens, at temperatures of greater than at least 212° F. Suitable materials for this application include MYLAR OL®.

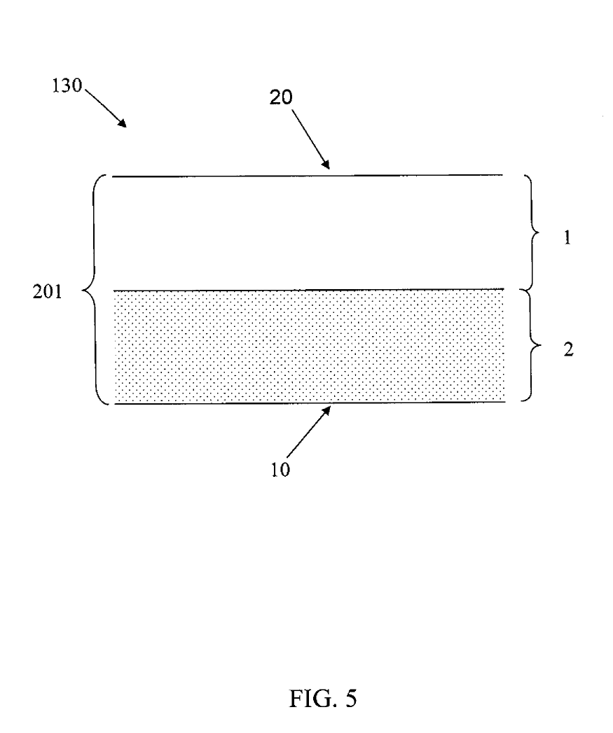

FIG. 5 is a cross sectional view of an exemplary film 201, comprising two layers, used in the formation of a high temperature lidding stock 130. The multilayer film 201 comprises an interior 10 and an exterior 20. This film 200 comprises a core layer 1 and a heat seal layer 2. In a preferred embodiment, the core layer 1 comprises nylon or polyester and the heat seal layer 2 comprises nylon blended with polyester elastomer or polyamide elastomer.

In one embodiment, the amount of nylon in the heat seal layer is greater than about 75% (by weight). In a more preferred embodiment, the amount of nylon in the heat seal layer is greater than about 80% (by weight). In a most preferred embodiment, the amount of nylon in the heat seal layer is greater than about 90% (by weight).

This film is suitable for high temperature applications. Furthermore, this film will provide a superior seal because the heat seal layer 2 will melt before the core layer 1. This ensures that the core layer 1 will not stretch and deform when the lidding stock 130 is heat sealed. When the core layer 1 comprises nylon, the lid has superior gas barrier properties. When the core layer 1 comprises polyester, the lid has superior moisture barrier properties, thus extending shelf-life.

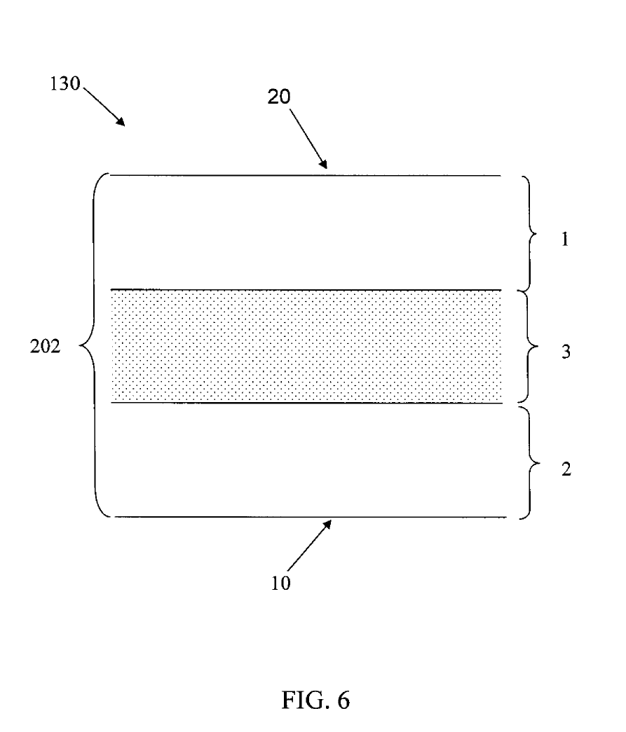

FIG. 6 is a cross sectional view of an exemplary multilayer film 202, comprising three layers, used in the formation of a high temperature lidding stock 130. The multilayer film 202 comprises an interior 10 and an exterior 20. As shown, the multilayer film 202 comprises a core layer 1, a heat seal layer 2, and a tie layer 3. In a preferred embodiment, the core layer 1 is nylon or polyester, the heat seal layer 2 is a polyester elastomer or polyamide elastomer, and the tie layer 3 is nylon or polyester, blended with a polyester elastomer or a polyamide elastomer.

In one embodiment, the amount of nylon or polyester in the tie layer is greater than about 75% (by weight). In a more preferred embodiment, the amount of nylon or polyester in the tie layer is greater than about 80% (by weight). In a most preferred embodiment, the amount of nylon or polyester in the tie layer is greater than about 90% (by weight).

This embodiment has several advantages. First, this film is suitable for high temperature applications. Second, a heat seal layer of polyester elastomer or polyamide elastomer will provide for superior heat seal characteristics along with reduced meat adhesion to the lidding stock 130 during or after the cooking process. When the core layer 1 comprises nylon, the thermoformed web has superior gas barrier properties. When the core layer 1 comprises polyester, the thermoformed web has superior moisture barrier properties, thus extending shelf-life. The tie layer 3 provides for a strong adhesion between the core layer 1 and heat seal layer 2 providing for a more stable lidding stock 130.

FIG. 7 illustrates an exemplary method of making an exemplary thermoformed web from a web stock and a lidding stock. FIG. 8 is a side view of the exemplary method of making an exemplary thermoformed web from a web stock and a lidding stock of FIG. 7. As shown in FIGS. 7 and 8, the web stock 105 may be manufactured from a sheet of film 100—Step 1. Film for the web stock may be pulled off a reel (not shown). The film is heated by a heating device (not shown) and webs 110 may be formed, forming a web tray 150 wherein the tray may comprise multiple webs, tubs, containers, etc. The resulting structure contains webs 110 for receiving product and ridge 120 that have not been transformed—Step 2. Suitable methods to form the web will be understood by one skilled in the art of thermoformed web production. These include, for example, vacuum assist, mechanical pressure, or air pressure to form the web into a female die. Alternatively, the male portion of the die may be used to push the material into the female portion of the die. Once the webs are formed, product 300 may be placed within the web—Step 3. Suitable products include food products, surgical instruments, and the like.

Film 200 for the lidding stock 130 may be pulled off of a reel (not shown) and placed above the webs—Step 4. The lidding stock 130 may be sealed to the web tray 150 enclosing the product and may form a hermetic seal—Step 5. A sealing device (not shown) may be used at Step 5 to seal 160 the lidding stock 130 to the ridges 120 on the web tray 150. Preferably, sealing is performed by the application of heat and pressure. In certain embodiments, air is removed from the web. In other embodiments, air may be replaced by a modified atmosphere. Suitable modified atmospheres include oxygen, nitrogen, helium, etc.

In Step 6, the web tray 150 may be cut with a cutting device (not shown), for example, forming web strips 500. These web strips 500 may be cut, for example, forming individual thermoformed webs 600—Step 7.

Those skilled in the art will appreciate that numerous changes and modifications may be made to the preferred embodiments of the invention and that such changes and modifications may be made without departing from the spirit of the invention. It is therefore intended that the appended claims cover all such equivalent variations as fall within the true spirit of the invention.

What is claimed:

1. A high temperature thermoformed web comprising:
a web stock;
one or more open webs thermoformed in the web stock;
a ridge extending around the perimeter of each of the one or more webs; and
a lidding stock that is attached to the ridge of the web stock to cover the one or more webs forming a closed web,
wherein the high temperature thermoformed web is suitable for use in a high temperature process that occurs at greater than about 212° F.

2. The thermoformed web of claim 1, wherein the web stock comprises a core layer comprising nylon blended with a polyester elastomer or a polyamide elastomer.

3. The thermoformed web of claim 1, wherein the web stock comprises a multi-layer film; the multi-layer film comprising:
a heat seal layer on an interior of the web stock;
a core layer on an exterior of the web stock; and
a tie layer between and connecting the heat seal layer and the core layer, the tie layer comprising at least some material of adjacent layers.

4. The thermoformed web of claim 3, wherein:
the heat seal layer comprises a polyester elastomer or a polyamide elastomer;
the core layer comprises nylon; and
the tie layer comprises nylon blended with a polyester elastomer or a polyamide elastomer.

5. The thermoformed web of claim 4, further comprising heat stabilizers added to the nylon to improves its heat stability.

6. The thermoformed web of claim 3, wherein:
the heat seal layer comprises a polyester elastomer or a polyamide elastomer;
the core layer comprises polyester; and
the tie layer comprises polyester blended with a polyester elastomer or a polyamide elastomer.

7. The thermoformed web of claim 3, wherein the tie layer comprises at least 75% (by weight) of the material of the core layer.

8. The thermoformed web of claim 3, further comprising an outer core layer, outside of the core layer and forming the exterior of the web stock.

9. The thermoformed web of claim 8, wherein the core layer comprises nylon 6 and the outer core layer comprises nylon 6,6.

10. The thermoformed web of claim 1, wherein the lidding stock comprises a core layer comprising nylon blended with polyester elastomer or polyamide elastomer.

11. The thermoformed web of claim 1, wherein the lidding stock comprises a multi-layer film comprising:
a core layer on an exterior of the lidding stock; and
a heat seal layer on an interior of the lidding stock.

12. The thermoformed web of claim 11, wherein, the core layer comprises nylon; and
the heat seal layer comprises nylon blended with polyester elastomer or polyamide elastomer.

13. The thermoformed web of claim 12, further comprising heat stabilizers added to the nylon to improves its heat stability.

14. The thermoformed web of claim 11, wherein,
the core layer comprises polyester; and
the heat seal layer comprises polyester blending with polyester elastomer or polyamide elastomer.

15. The thermoformed web of claim 11, further comprising a tie layer between the core layer and the heat seal layer, the tie layer comprising at least some material of adjacent layers.

16. The thermoformed web of claim 15, wherein the tie layer comprises at least 75% (by weight) of the material of the core layer.

17. The thermoformed web of claim 15, wherein,
the core layer comprises nylon;
the heat seal layer comprises a polyester elastomer or polyamide elastomer; and
the tie layer comprises nylon blended with a polyester elastomer or a polyamide elastomer.

18. The thermoformed web of claim 15, wherein,
the core layer comprises polyester;
the heat seal layer comprises a polyester elastomer or polyamide elastomer; and
the tie layer comprises polyester blended with a polyester elastomer or a polyamide elastomer.

19. The thermoformed web of claim 1, wherein the high temperature process is cooking of a food product.

20. The thermoformed web of claim 1, wherein the high temperature process is sterilization of medical instruments.

21. The thermoformed web of claim 1, wherein the high temperature process occurs at greater than about 300 degrees Fahrenheit.

22. The thermoformed web of claim 1, wherein the high temperature process occurs at greater than about 350 degrees Fahrenheit.

23. The thermoformed web of claim 1, wherein high temperature process comprises a high temperature food preparation process that occurs at from about 212 degrees Fahrenheit to about 400 degrees Fahrenheit.

24. The thermoformed web of claim 1, wherein the lidding layer is capable of venting, wherein the lidding stock loosens from the web stock at a temperature of greater than about 212 degrees Fahrenheit to allow venting of gasses from the thermoformed web.

25. The thermoformed web of claim 1, having a tensile yield strength of greater than about 2000 psi.

26. The thermoformed web of claim 1, having an oxygen barrier transmission coefficient of approximately 30 cc/24 hr/100 in²/mil or less.

27. The thermoformed web of claim 1, having a water vapor barrier transmission coefficient of approximately 40 g/24 hr/100 in²/mil or less.

28. The thermoformed web of claim 1, wherein the thermoformed web does not substantially adhere to food during said high temperature food preparation process.

29. A method of making thermoformed webs for packaging and high temperature cooking of food products comprising:
providing a film of web stock comprising a thermoformable material and a heat sealing material;
thermoforming one or more webs in the film of web stock to form a web tray; and
covering and sealing the web tray with a film of lidding stock to form a sealed web tray, the lidding stock film comprising a heat sealing material;
wherein the sealed web tray is capable of cooking a product contained within the one or more webs at a temperature above 212 degrees Fahrenheit.

30. The method of claim 29, further comprising forming the film of web stock as a mono-layer film, the mono-layered film of the web stock comprising:
blending a core material with an elastomer material, the blended mono-layer comprising at least about 75% of the core material.

31. The method of claim 29, further comprising forming the film of lidding stock as a mono-layer film, the mono-layered film of the lidding stock comprising:
blending a core material with an elastomer material, the blended mono-layer comprising at least about 75% of the core material.

32. The method of claim 29, further comprising:
forming an interior layer of the film of web stock and an interior layer of the film of lidding stock in part from an elastomer material, the elastomer material comprising polyester elastomer or polyamide elastomer; and
matching the elastomer materials of the film of web stock and the film of lidding stock to facilitate heat sealing of the film of web stock and the film of lidding stock together.

33. The method of claim 29, further comprising forming the film of web stock as a multi-layer film, formation of the multi-layer film of web stock further comprising:
providing a core layer comprising a core material;
providing a heat seal layer comprising polyester elastomer or polyamide elastomer; and
blending the elastomeric material of the heat seal layer with the core material of the core layer to form a tie layer, wherein at least 75% (by weight) of the tie layer comprises core material; and
tying the core layer and heat seal layer together using the tie layer.

34. The method of claim 33, further comprising:
providing a core layer comprising a core material of nylon;
providing an outer core layer on an exterior of the core layer, the outer core layer comprising a core material of nylon 6,6; and
connecting the outer core layer and the core layer together.

35. The method of claim 29, further comprising forming the film of lidding stock as a multi-layer film, formation of the multi-layer film of lidding stock further comprising:
providing a core layer comprising a core material;
providing a heat seal layer comprising polyester elastomer or polyamide elastomer; and
connecting the core layer and the heat seal layer together.

36. The method of claim 35, further comprising providing a tie layer between the core layer and the heat seal layer, wherein the tie layer comprises:
blending the elastomeric material of the heat seal layer with the core material of the core layer, wherein at least 75% (by weight) of the tie layer comprises core material; and
tying the core layer and heat seal layer together using the tie layer.

37. The method of claim 29, further comprising forming a gas barrier, the gas barrier being formed by including a material comprising a nylon having an oxygen barrier transmission coefficient of about 10 cc/24 hr/100 in²/mil or less.

38. The method of claim 29, further comprising forming a moisture barrier, the moisture barrier being formed by including a material comprising a polyester having a water vapor barrier transmission coefficient of about 10 g/24 hr/100 in²/mil or less.

39. The method of claim 29, further comprising forming tear and puncture resistant webs, the tear and puncture resistant webs being formed by including a material comprising a polyester elastomer or a polyamide elastomer having a tear strength of greater than about 75 g/mil and a tensile yield strength of greater than about 2,500 psi.

40. The method of claim 29, further comprising separating the sealed web tray to produce individual sealed thermoformed webs.

41. The method of claim 29, wherein the thermoformed web is used for: food packaging, food storage, and food cooking.

42. A system for packaging and cooking meat products comprising:
web stock comprising:
a material that may be thermoformed to form one or more webs;
a material on an interior of the web stock that may be heat sealed;
a material on an interior of the web stock that substantially does not stick to the meat product during cooking;
lidding stock connected to the web stock and covering the thermoformed webs of the web stock, the lidding stock comprising:
a material on an interior of the lidding stock that may be heat sealed to connect the lidding stock to the web stock;
wherein the web stock and the lidding stock are suitable for use in high temperature applications having temperatures greater than about 212 degrees Fahrenheit.

43. The system of claim 42, wherein the material that may be thermoformed further comprises:
a polyester elastomer; or
a polyamide elastomer.

44. The system of claim 42, wherein the web stock and/or the lidding stock further comprise a material having a good gas barrier property, the material having a good gas barrier property having an oxygen barrier transmission coefficient of about 30 cc/24 hr/100 in²/mil or less.

45. The system of claim 44, wherein the material having a good gas barrier property comprises:
a nylon; or
a nylon blended with an elastomer.

46. The system of claim 42, wherein the web stock and/or the lidding stock further comprise a material having a good moisture barrier property, the material having a good moisture barrier property having a water vapor barrier transmission coefficient of about 40 g/24 hr/100 in²/mil or less.

47. The system of claim 46, wherein the material having a good moisture barrier property comprises:
a polyester; or
a polyester blended with an elastomer.

48. The system of claim 47, wherein the material having a good moisture barrier property further comprises oriented polyester, wherein the oriented polyester comprises a blend of polyester and about 5% to about 25% (by weight) of a polyester elastomer.

49. The system of claim 42, the web stock and/or the lidding stock further comprise a durable material having a good tear strength and good puncture resistance, the durable material comprising a tear strength of greater than about 75 g/mil and a tensile yield strength of greater than about 2,500 psi.

50. The system of claim 49, wherein the durable material comprises:
a polyester elastomer; or
a polyamide elastomer.

51. The system of claim 42, wherein the web stock further comprises a thickness of between about 2.5 mil and about 4 mil, and wherein the lidding stock comprises a thickness of between about 1 mil to about 2 mil.

52. The system of claim 42, wherein substantially no sticking of the meat product during cooking means that less than about 5% by weight of the meat product sticks to the material.

53. The system of claim 52, wherein the material comprises:
a polyester elastomer; or
a polyamide elastomer.

54. The system of claim 42, wherein the web stock and the lidding stock further comprise one of: a monolayer or a multilayer film.

55. The system of claim 54, wherein the multilayer film comprises adjacent layers, each adjacent layer having at least some of the same material of an adjacent layer or adjacent layers.

56. The system of claim 55, wherein the multilayer film further comprises a tie layer, the tie layer comprising at least 75% (by weight) of a core material of one adjacent layer and one of:
a polyester elastomer; or
a polyamide elastomer; and
the core material comprising:
a nylon; or
a polyester.

57. The system of claim 42, wherein the material of the web stock and the material of the lidding stock to be heat sealed comprise at least some of the same material on the interior of the web stock and the interior of the lidding stock, wherein the same material facilitates heat sealing together of the web stock and the lidding stock.

58. The system of claim 57, wherein the same material of the web stock and the lidding stock comprises: a polyester elastomer; or a polyamide elastomer.

59. The system of claim 58, wherein the same material of the web stock and the lidding stock comprises: 100% of a polyester elastomer; or 100% of a polyamide elastomer.

60. The system of claim 42, wherein the lidding stock further comprises a material on an interior of the lidding stock that substantially does not stick to the meat product during cooking.

61. The system of claim 60, wherein the material on an interior of the lidding stock that substantially does not stick to the meat product during cooking comprises: a polyester elastomer; or a polyamide elastomer.
